(19) United States
(12) Patent Application Publication
(10) Pub. No.: US 2014/0168104 A1
(43) Pub. Date: Jun. 19, 2014

(54) ELECTRONIC DEVICE AND METHOD FOR PROVIDING TACTILE STIMULATION

(71) Applicants: Fu Tai Hua Industry (Shenzhen) Co., Ltd., (US); Hon Hai Precision Industry Co., Ltd., (US)

(72) Inventor: SHANG-QING ZHOU, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/729,048

(22) Filed: Dec. 28, 2012

(30) Foreign Application Priority Data
Dec. 13, 2012 (CN) 201210538623.5

(51) Int. Cl. G06F 3/041

(52) U.S. Cl. CPC G06F 3/0416
USPC 345/173

(57) ABSTRACT

A method for providing tactile stimulation is applied in an electronic device. The electronic device includes a touch-sensitive screen and a tactile stimulation multilayer connected to the touch-sensitive screen. The tactile stimulation multilayer includes a number of electrodes. The method includes follow steps: detecting at least one touch point on the touch-sensitive screen; determining position information of each touch point and an occurrence time of touching each touch point; determining electrodes each corresponding to the position information of one touch point and energizing the determined electrodes; extracting a number of successively detected touch points and determining whether a slide operation is exerted on the touch-sensitive screen; calculating an anticipated trajectory of the slide operation if a slide operation is exerted on the touch-sensitive screen; and determining a number of electrodes each corresponding to position information of one touch point forming the anticipated trajectory and energizing the determined electrodes.

### BACKGROUND

1. Technical Field

The present disclosure relates to electronic devices, and particularly, to an electronic device and a method for providing tactile stimulation adapted for the electronic device.

2. Description of Related Art

Many electronic devices, such as mobile phones, tablet computers, and multimedia players, employ touch-sensitive screens as input interfaces. When a user presses one virtual graphical button or icon displayed on a touch-sensitive screen, the graphical button or icon does not provide very good tactile feedback to the user as a conventional keyboard does which has a travel distance for a keystroke when operated. In order to improve the user experience, a number of vibrating mechanical members are arranged under the touch-sensitive screen. When sensing a touch operation on the touch-sensitive screen, the vibrating mechanical member at a corresponding location begins to vibrate to provide tactile feedback to the user. However, a problem shared by most such electronic devices is that such tactile sensation usually delays if the touch operation performs very fast on the touch-sensitive screen.

Recently, a technology of enabling the touch-sensitive screen to provide tactile feedback is realized by delivering an electrosensory sensation in response to a touch operation on the touch-sensitive screen. However, there are less developments on how this kind of tactile feedback is applied in response to a touch gesture, and how to speed up the tactile sensation to bring a new level of tactile experience to the user.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a perspective view of a touch-sensitive screen included in an electronic device, in accordance with an exemplary embodiment.

FIG. 2 is a perspective view of a tactile stimulation multilayer connected to the touch-sensitive screen of FIG. 1, in accordance with an exemplary embodiment.

FIG. 3 is a block diagram of a tactile stimulation system applied to the electronic device of FIG. 1, in accordance with an exemplary embodiment.

FIG. 4 is a schematic view showing a anticipated trajectory and a subsequent touch trajectory of a slide operation performed on the touch-sensitive screen of FIG. 1, in accordance with an exemplary embodiment.

FIG. 5 is a flowchart of a method for providing tactile stimulation, in accordance with an exemplary embodiment.

### DETAILED DESCRIPTION

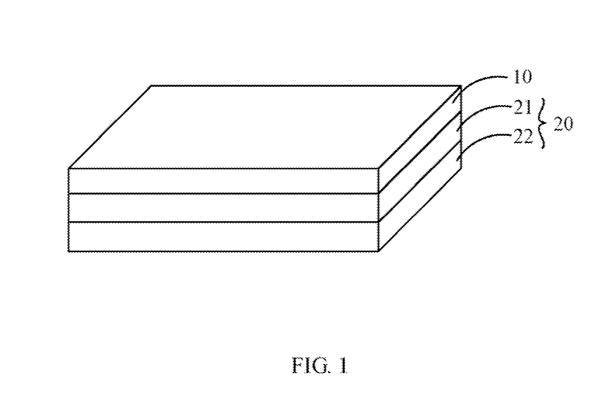

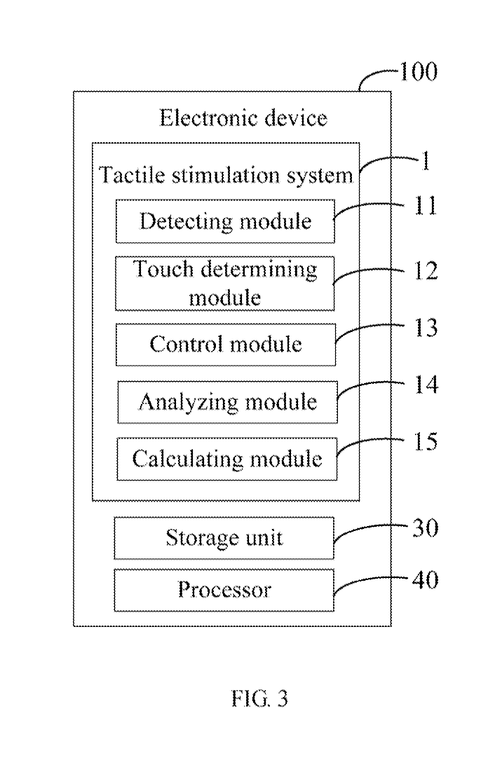

FIG. 1 is a perspective view of a touch-sensitive screen 10 of an electronic device 100 according to an exemplary embodiment. The electronic device 100 may be a mobile phone, a tablet computer, or a multimedia player for example. A tactile stimulation multilayer 20 is connected to the screen 10, and is arranged above or under the screen 10. The multilayer 20 includes a number of electrodes 220 (further shown in FIG. 3) which can be independently controlled. The electronic device 100 further includes a storage unit 30 and a processor 40 (further shown in FIG. 3). The storage unit 30 stores a relationship between a number of positions of the screen 10 and the electrodes 220. Each position corresponds to one electrode 220. The storage unit 30 further stores a tactile stimulation system 1. The system 1 includes a variety of modules executed by the processor 40 to provide the functions of the system 1. In this embodiment, the system 1 is executed by the processor 40 to detect touch operation on the screen 10 by a body member to be stimulated (e.g., a finger) and employ position information of the touch operation to energize the corresponding electrode 220 in the multilayer 20 to provide tactile stimulation. A detail description of the tactile stimulation multilayer 20 will be described as follows.

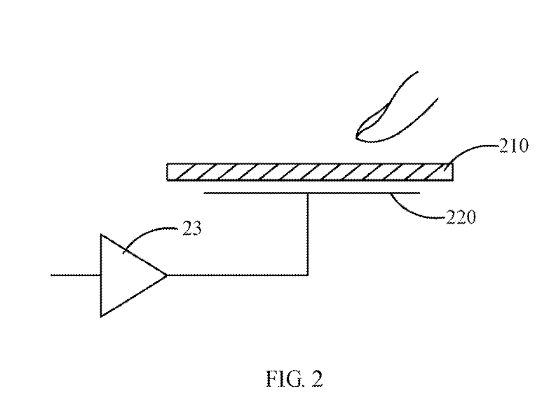

FIG. 2 shows that the multilayer 20 includes an insulation layer 21 and an electrode layer 22. The said electrodes 220 are included in the electrode layer 22. The electrodes 220 are connected to a power supply unit 23, and can be independently energized via the power supply unit 23. The insulation layer 21 includes a number of insulators 210, and each insulator 210 corresponds to one electrode 220. In the embodiment, the multilayer 20 is arranged under the screen 10, and the insulation layer 21 is arranged between the multilayer 20 and the electrode layer 22. Furthermore, when a body member which is a relatively good insulator when dry touches the multilayer 20, the body member and the multilayer 20 cooperatively form a imaginary capacitor. Then, the system 1 determines the position of the body member on the screen 10 and energizes the electrode 220 corresponding to the determined position via the power supply unit 23, thus, static charges generated on the body member because of a capacitive coupling between the determined electrode 220 and the body member, and the generated static charges flows to form electrical current which delivers a tactile stimulation to the body member.

FIG. 3 shows that in the embodiment, the system 1 includes a detecting module 11, a touch determining module 12, a control module 13, an analyzing module 14, and a calculating module 15.

The detecting module 11 detects at least one touch point on the screen 10 according to touch signals from the screen 10.

The touch determining module 12 determines position information of each touch point and an occurrence time of touching each touch point (hereinafter, touch time).

The control module 13 determines a number of electrodes 220 each corresponding to the position information of one touch point according to the relationship between the positions and the electrodes 220, and then energizes the determined electrodes 220 via the power supply unit 23. Thus, a tactile stimulation is provided to the body member touching the screen 10.

The analyzing module 14 extracts a number of successively detected touch points and determines whether a slide operation is exerted on the screen 10 according to the position information of each extracted touch point. In the embodiment, the analyzing module 14 first determines whether the extracted touch points are continuous according to the position information of the extracted touch points. If so, the analyzing module 14 further determines whether a length of a line connecting the extracted touch points is greater than a predetermined length. If so, the analyzing module 14 determines that a slide operation is exerted on the screen 10. In the embodiment, the analyzing module 14 determines two touch points to be continuous if a distance between the touch points is less than a predetermined distance.

The calculating module 15 calculates an anticipated trajectory of the slide operation according to the position information and touch time of each extracted touch point if a slide operation is exerted on the screen 10. The anticipated trajectory may be a subsequent touch trajectory of the slide operation, and the subsequent touch trajectory includes new touch points touched after the successively detected touch points, enabling a slide trajectory to be established. A detail description of the calculation of the anticipated trajectory will be described as follows.

In the embodiment, the analyzing module 14 extracts four successively detected touch points P1 (X₁, Y₁, t₁), P2 (X₂, Y₂, t₂), P3 (X₃, Y₃, t₃), and P4 (X₄, Y₄, t₄) to allow the calculating module 15 to calculate the anticipated trajectory. Where (X, Y) denotes the position information of each extracted touch point, and t denotes the touch time of each extracted touch point. The analyzing module 14 further calculates a slide speed and a slide acceleration of the slide operation according to the position information and the touch time of each extracted point. Then, the calculating module 15 calculates the anticipated trajectory according to the position information, the touch time, the slide speed and the slide acceleration, which is described as a function F(X, Y):

X_{new}=X_{old}+½ α̅ₓΔt²+ v̅ₓΔt

Y_{new}=Y_{old}+½ α̅_{y}Δt²+ v̅_{y}Δt

Where (X_{new}, Y_{new}) denotes position information of a new touch point, (X_{old}, Y_{old}) denotes the lastly extracted touch point, α̅ₓ and α̅_{y} denote average slide accelerations of the slide operation, V̅ₓ and V̅_{y} denote average slide speeds of the slide operation, At denotes a time interval between each of two adjacent extracted touched points, which can be obtained according to the touch time of the extracted touch points.

The control module 13 further determines a number of electrodes 220 each corresponding to position information of one touch point forming the anticipated trajectory according to the relationship between the positions and the electrodes 220, and energizes the determined electrodes 220 via the power supply unit 23. Thus, a tactile stimulation is provided in advance before the body member actually touches the screen 10 to avoid a delay of the tactile stimulation.

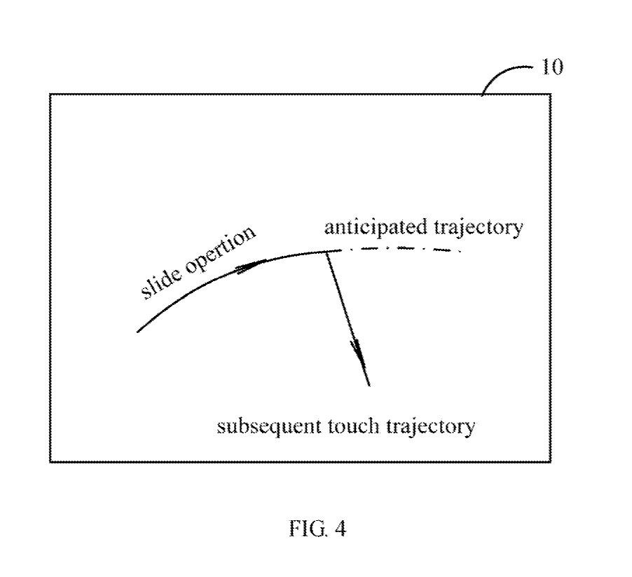

In the embodiment, the analyzing module 14 further determines whether a subsequent touch trajectory of the slide operation is along the anticipated trajectory (see FIG. 4). If the subsequent touch trajectory of the slide operation is not along the anticipated trajectory (e.g., the body member suddenly changes a direction of the slide operation), the control module 13 stops energizing the electrodes 220 corresponding to position information of the touch points forming the anticipated trajectory.

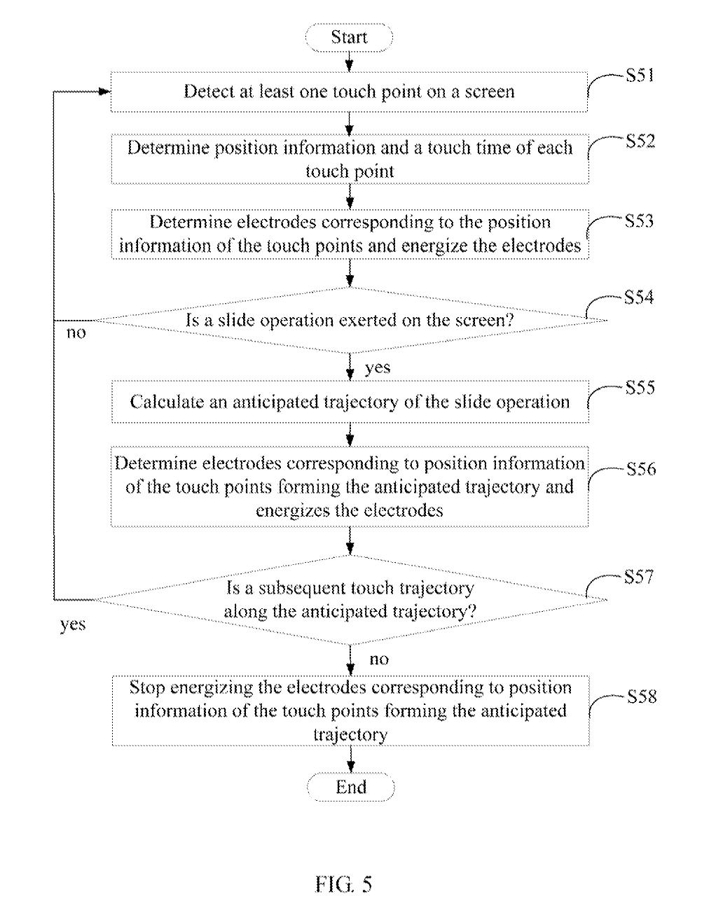

FIG. 5 is a flowchart of a method for providing tactile stimulation, in accordance with an exemplary embodiment.

In step S51, the detecting module 11 detects at least one touch point on the screen 10 according to touch signals from the screen 10.

In step S52, the touch determining module 12 determines position information of each touch point and a touch time of touching each touch point.

In step S53, the control module 13 determines a number of electrodes 220 each corresponding to the position information of one touch point according to the relationship between the positions and the electrodes 220, and then energizes the determined electrodes 220 via the power supply unit 23.

In step S54, the analyzing module 14 extracts a number of successively detected touch points and determines whether a slide operation is exerted on the screen 10 according to the position information of each extracted touch point, if yes, the procedure goes to step S55; otherwise, the procedure goes back to step S51.

In step S55, the calculating module 15 calculates an anticipated trajectory of the slide operation according to the position information and touch time of each extracted touch point. The anticipated trajectory may be a subsequent touch trajectory of the slide operation, and the subsequent touch trajectory includes new touch points touched after the successively detected touch points.

In step S56, the control module 13 determines a number of electrodes 220 each corresponding to position information of one touch point forming the anticipated trajectory according to the relationship between the positions and the electrodes 220, and energizes the determined electrodes 220 via the power supply unit 23. Thus, a tactile stimulation is provided in advance before the body member touches the screen 10 to avoid a delay of the tactile stimulation.

In step S57, the analyzing module 14 determines whether a subsequent touch trajectory of the slide operation is along the anticipated trajectory, if yes, the procedure goes back to step S51; otherwise, the procedure goes to step S58.

In step S58, the control module 13 stops energizing the electrodes 220 corresponding to position information of the touch points forming the anticipated trajectory.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch-sensitive screen;
a tactile stimulation multilayer connected to the touch-sensitive screen, the tactile stimulation multilayer comprising a plurality of electrodes;
a storage unit storing a plurality of modules and a first relationship between positions of the touch-sensitive screen and the electrodes, each position corresponding to one of the electrodes; and
a processor to execute a plurality of modules, and the plurality of modules comprising:
a detecting module to detect detects at least one touch point according to touch signals from the touch-sensitive screen;
a touch determining module to determine position information of each touch point and an occurrence time of touching each touch point;
an analyzing module to extract a plurality of successively detected touch points and determine whether a slide operation is exerted on the touch-sensitive screen according to the position information of each extracted touch point;
a calculating module to calculate an anticipated trajectory of the slide operation according to the position information and occurrence time of each extracted touch point if a slide operation is exerted on the touch-sensitive screen; and
a control module to determine a plurality of electrodes each corresponding to the position information of one touch point according to the relationship between the positions and the electrodes and energize the determined electrodes; and determine a plurality of electrodes each corresponding to position information of one touch point forming the anticipated trajectory according to the relationship between the positions and the electrodes and energize the determined electrodes.

2. The electronic device of claim 1, wherein the analyzing module is configured to first determine whether the extracted touch points are continuous according to the position information of the extracted touch points, determines whether a length of a line connecting the extracted touch points is greater than a predetermined length if the extracted touch points are continuous, and then determines that a slide operation is exerted on the touch-sensitive screen if the length of a line connecting the extracted touch points is greater than the predetermined length.

3. The electronic device of claim 2, wherein the analyzing module determines two touch points to be continuous if a distance between the touch points is less than a predetermined distance.

4. The electronic device of claim 1, wherein the analyzing module is further configured to calculate a slide speed and a slide acceleration of the slide operation according to the position information and occurrence time of each extracted point, and the calculating module is configured to calculate the anticipated trajectory according to the position information, the occurrence time, the slide speed and the slide acceleration, which is described as a function F(X, Y):
X_{new}=X_{old}+½ α̅ₓΔt²+ v̅ₓΔt
Y_{new}=Y_{old}+½ α̅_{y}Δt²+ v̅_{y}Δt
wherein (X_{new}, Y_{new}) denotes position information of a new touch point; (X_{old}, Y_{old}) denotes a lastly extracted touch point; α̅ₓ and α̅_{y} denote average slide accelerations of the slide operation; V̅ₓ and V̅_{y} denote average slide speeds of the slide operation; At denotes a time interval between each of two adjacent extracted touched points, which can be obtained according to the occurrence time of the extracted touch points.

5. The electronic device of claim 1, wherein the analyzing module is further configured to determine whether a subsequent touch trajectory of the slide operation is along the anticipated trajectory, and stop energizing the electrodes corresponding to position information of the touch points forming the anticipated trajectory if the subsequent touch trajectory is not along the anticipated trajectory.

6. A method for providing tactile stimulation applied in an electronic device, the electronic device comprising a touch-sensitive screen and a tactile stimulation multilayer connected to the touch-sensitive screen, the tactile stimulation multilayer comprising a plurality of electrodes, the method comprising:
detecting at least one touch point according to touch signals from the touch-sensitive screen;
determining position information of each touch point and an occurrence time of touching each touch point;
determining a plurality of electrodes each corresponding to the position information of one touch point according to a relationship between the positions and the electrodes stored in the electronic device and energizing the determined electrodes;
extracting a plurality of successively detected touch points and determining whether a slide operation is exerted on the touch-sensitive screen according to the position information of each extracted touch point;
calculating an anticipated trajectory of the slide operation according to the position information and occurrence time of each extracted touch point if a slide operation is exerted on the touch-sensitive screen; and
determining a plurality of electrodes each corresponding to position information of one touch point forming the anticipated trajectory according to the relationship between the positions and the electrodes and energizing the determined electrodes.

7. A storage medium storing a plurality of modules, the plurality of modules comprising instructions executable by a processor of an electronic device to perform a method for providing tactile stimulation, the electronic device comprising a touch-sensitive screen Page 13 of 15 and a tactile stimulation multilayer connected to the touch-sensitive screen, the tactile stimulation multilayer comprising a plurality of electrodes, the method comprising:
detecting at least one touch point according to touch signals from the touch-sensitive screen;
determining position information of each touch point and an occurrence time of touching each touch point;
determining a plurality of electrodes each corresponding to the position information of one touch point according to a relationship between the positions and the electrodes and energizing the determined electrodes;
extracting a plurality of successively detected touch points and determining whether a slide operation is exerted on the touch-sensitive screen according to the position information of each extracted touch point;
calculating an anticipated trajectory of the slide operation according to the position information and occurrence time of each extracted touch point if a slide operation is exerted on the touch-sensitive screen; and
determining a plurality of electrodes each corresponding to position information of one touch point forming the anticipated trajectory according to the relationship between the positions and the electrodes and energizing the determined electrodes.
